(19) United States
(12) Patent Application Publication
(10) Pub. No.: US 2008/0015757 A1
(43) Pub. Date: Jan. 17, 2008

(54) Method for Multi-Operating Mode Control of an Automated Transmission for a Motor Vehicle, in Particular for Idle Speed Running With Activated Brake and Corresponding Device

(75) Inventors: Frederic Roudeau, Vitry Sur Seine (FR); Jean Bretheau, Antony (FR); Vincent Vermuse, St. Germain Les Arpajon (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/575,055

(22) PCT Filed: Sep. 6, 2005
(86) PCT No.: PCT/FR05/50712

§ 371 Date: May 29, 2007

(30) Foreign Application Priority Data
Sep. 10, 2004 (FR) 0409649

(51) Int. Cl. G06F 17/00; B60W 10/02

(52) U.S. Cl. 701/51; 477/176

(57) ABSTRACT

A method for controlling an automated transmission for a power train of a motor vehicle produces a first setpoint signal of a variable that is applicable to the vehicle wheels and that includes dynamic and static components formed taking into consideration input representative data of the motor vehicle characteristics, a driver's wish, and an environment of the vehicle, in selecting, according to the input data, one mode from at least two different operating modes able to transmit the setpoint signal. One operating mode corresponds to a torque creeping mode for transmitting the setpoint signal when the motor vehicle runs with a speed lower than a predetermined threshold and the brake pedal thereof is activated.

The present invention relates to the control of the operating mode of a power train equipped with a motor vehicle automated transmission.

This control device advantageously applies to automated transmissions in particular to Impulse Control Boxes termed BCI, Automatic Control Boxes termed BVA and Robotized Gear Boxes termed BVR, but also continuous-ratio transmissions, such as CVT (“Continuous Variable Transmission”), IVT (“Infinitely Variable Transmission”) and hybrid transmissions.

A transmission conventionally comprises a control block receiving one or more input parameters interpreting the desire of the driver. Then, as a function of the value of these parameters, this control block delivers a control setpoint with a view to application to the wheels of the motor vehicle.

An upgrade of such a control block has already been described in document FR-A-2827339, in the name of the Applicant. This document details a device for controlling the operating point of a power train. The control carried out by this device is a torque control applied to the wheels of the motor vehicle. As defined in document FR-A-2827339, the value of the torque to be applied to the wheels of the motor vehicle, is calculated directly at the wheels of the motor vehicle.

The device of document FR-A-2827339 possesses a module for interpreting the desire of the driver called an IVC module.

The IVC module generates a torque setpoint to be applied to the wheels, destined for a block for optimizing the operating point OFF. The latter transmits said torque with a view to a torque control to be applied to the wheels of the motor vehicle. The OFF block simultaneously generates an engine revs setpoint on the basis of said torque to be applied to the wheels of the motor vehicle. This torque setpoint is determined as a function of the desire of the driver, of the characteristics of the motor vehicle and of its environment.

However, in the case of an automated transmission, there exist specific nodes such as the “Creeping” mode and the “Neutral” mode, linked with the automated transmission and that are not found in the case of a mechanical transmission. The “Creepinge” mode corresponds to an idling advance of the motor vehicle, when the gear lever is in the position termed “Drive” or “D”. The “Neutral” mode corresponds to a freewheeling advance of the motor vehicle when the control lever is in the position termed “Neutral” or “N”.

The module to interpreting the desire of the driver of document FR-A-2827339 does not take these particular modes of operation into account, in particular in the case where the motor vehicle crawls forward while having load or slope constraints for example. In this configuration, the motor vehicle must also overcome drag forces, that is to say a friction torque or the parts of the whole set of parts of the transmission chain. These drag forces substantially increase the fuel consumption of the motor vehicle, in particular when the latter is stationary.

A device which prevents the motor vehicle from going backward as it crawls forward on an inclined plane is known for this operating mode, through document U.S. Pat. No. 5,549,525 (ZF). Therefore, the device envisages control but only at the transmission level.

A control device for reducing the drag of an automatic box with torque converter, when the motor vehicle is stationary, as also known through document FR 2,806,670 in the name of the Applicant. The technical solution afforded by this device consists in automatically declutching while stationary so as to reduce the number of parts to be driven and therefore the fuel consumption.

The present invention is aimed at alleviating the defects of the various solutions described in the aforesaid patent applications so as to meet the desire of the driver as far as possible, in particular when the motor vehicle is in the “Creeping” mode. The invention is also aimed at allowing the switch from one operating mode to another, while avoiding the phenomenon of mode oscillations, that is to say fast alternation from one mode to another on account of the oscillating of a parameter about a threshold value.

Accordingly, the invention proposes a method of controlling an automated transmission of a power train for a motor vehicle, comprising a step of formulating a setpoint signal of a variable to be applied to the wheels of the motor vehicle, said setpoint comprising a dynamic component and a static component formulated by taking account of input data representative of the characteristics of the motor vehicle, of the desire of the driver and of the environment of the motor vehicle. As a function of said input data, a mode is selected from among at least two different operating modes, capable of delivering said se setpoint signal, one of the two operating modes corresponding to a mode termed “Torque Creeping” able to deliver said setpoint signal when the motor vehicle advances at a speed less than a predetermined threshold and when the brake pedal of the motor vehicle is activated.

The mode termed “Torque Creeping” makes it possible to offer a mode of driving appropriate to the movement of the motor vehicle at very low speed and while idling, when the driver activates the brake pedal. This mode of driving will make it possible in particular to reduce the drag forces, of the transmission box, that are particularly significant when the motor vehicle is stationary. By reducing these forces the fuel consumption of the motor vehicle is consequently decreased.

According to a mode of implementation the “Torque Creeping” mode and/or the value of the setpoint delivered when said “Torque Creeping” mode is selected, are determined as a function of a signal representative of the whole set of resistive torques applied to the motor vehicle, measured at the wheel of the motor vehicle and representative of the load carried on board by the motor vehicle and/or of the unevennesses of the road profile.

According to a mode of implementation, the “Torque Creeping” mode and/or the value of the setpoint delivered when said “Torque Creeping” mode is selected, are determined as a function of a signal representative of the dynamic component of the setpoint undergoing application.

According to a mode of implementation, the “Torque Creeping” mode and/or the value of the setpoint delivered when said “Torque Creeping” mode is selected, are determined as a function of a signal representative of the resistive torques (Cres) measured or estimated at the wheel and that the motor vehicle must overcome so as to be able to move off.

The invention also proposes a device for controlling an automated transmission of a power train for a motor vehicle, able to deliver setpoint signals of a variable to be applied to the wheels of the motor vehicle, said setpoint comprising a dynamic component and a static component formulated by taking account of input data, delivered by an input block and comprising a list of parameters defining the characteristics of the motor vehicle, the desire of the driver and the environment of the motor vehicle. The device comprises

a control block comprising at least two modules according to two distinct and predetermined operating modes, one of the modules corresponding to a mode termed “Torque Creeping”, selected when the motor vehicle advances at a speed less than a predetermined threshold, when the acceleration pedal is less than another predetermined threshold and when the brake pedal of the motor vehicle is activated,

a selection module receiving the signals originating from said input block and able to deliver a selection signal for an operating mode module as a function of the input data.

According to an embodiment, the module intended for the operating mode termed “Torque Creeping” comprises:

a first block able to formulate a raw dynamic component of the setpoint as a function of a predetermined parameter list,

a temporal filter capable of delaying the variable that it receives input,

a second block able to formulate a validation variable so as to activate the temporal filter, when a signal indicating entry into the “Torque Creeping” mode switches from the value “0” to the value “1”,

a third block able to formulate a state variable indicating whether we are in a phase termed of “drag reduction while stationary”, as a function of the first predetermined list of parameters,

a forth block able to calculate a modulation coefficient on the basis of the state variable, so as progressively to apply the correction afforded during said “drag reduction while stationary” phase,

means for performing operations on the variables delivered by the blocks included in the module intended for the operating mode termed “Torque Creeping” as a function of a third list of predetermined input parameters,

a delay means for delaying the dynamic component of the setpoint undergoing application,

means for storing calibratable parameters,

means for comparing the dynamic component, the value of a raw static component and a minimum torque quantity applicable to the wheel, with a signal representative of the resistive torques applied to the wheel and that the motor vehicle must overcome so as to be able to move off.

According to an embodiment, the list of predetermined parameters comprises the speed of the motor vehicle and a signal representative of the whole set of resistive torques applied to the motor vehicle, measured or estimated at the wheel of the motor vehicle and representative of the load carried on board by the motor vehicle and/or of the unevennesses of the road profile.

Other advantages and characteristics of the invention will appear on examination of the detailed description of a wholly nonlimiting mode of implementation of the invention, and of the appended drawings, in which:

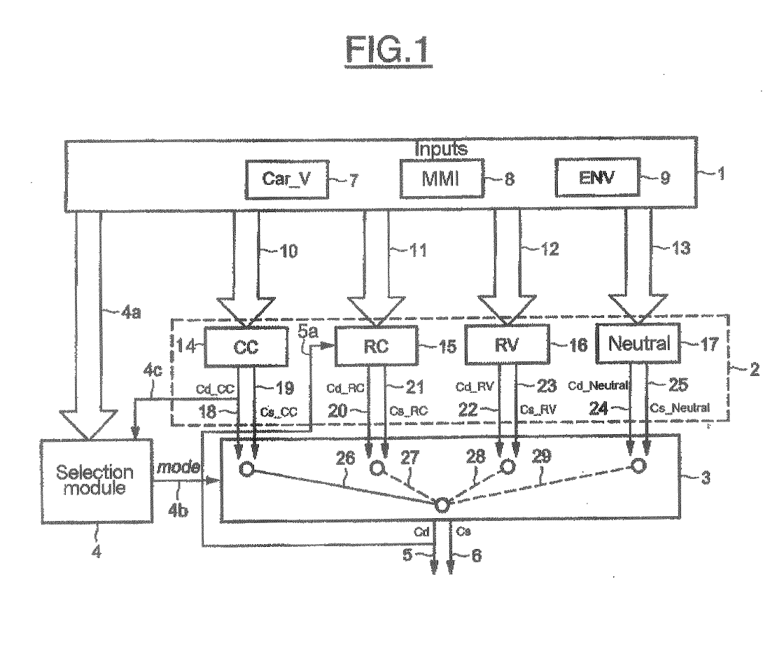

FIG. 1 diagrammatically illustrates an exemplary embodiment of a device according to the invention,

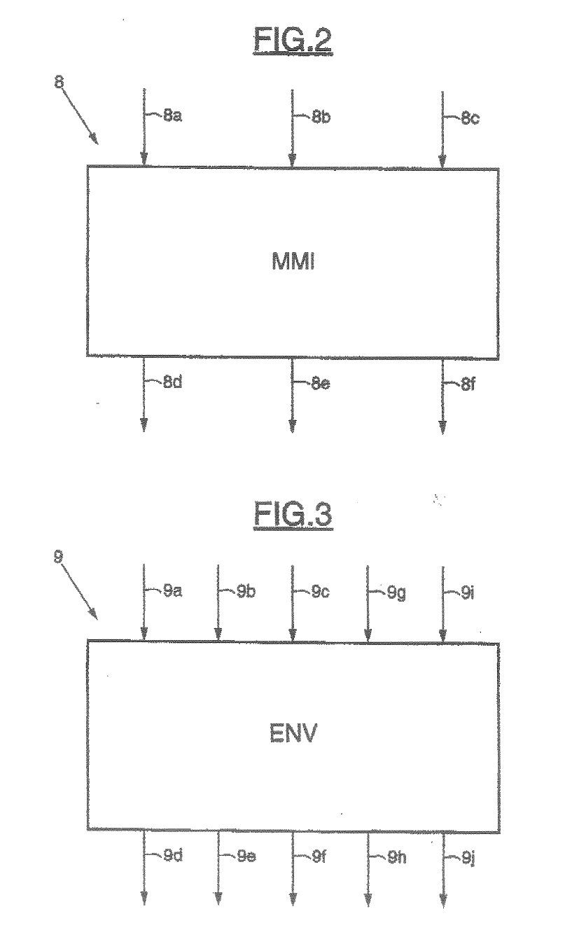

FIG. 2 diagrammatically illustrates and in greater detail a part of FIG. 1,

FIG. 3 diagrammatically illustrates and in greater detail a part of FIG. 1,

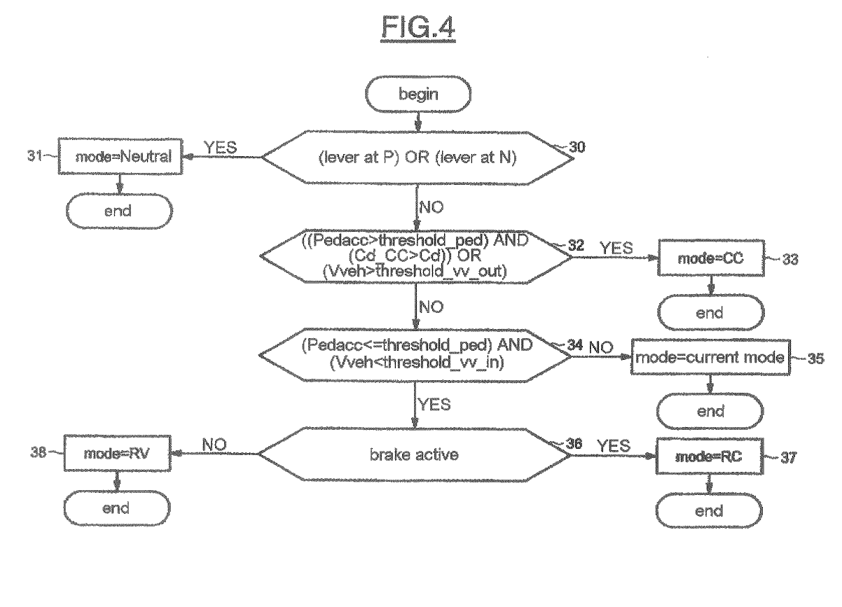

FIG. 4 illustrates an example of the various steps during the selection of an operating mode.

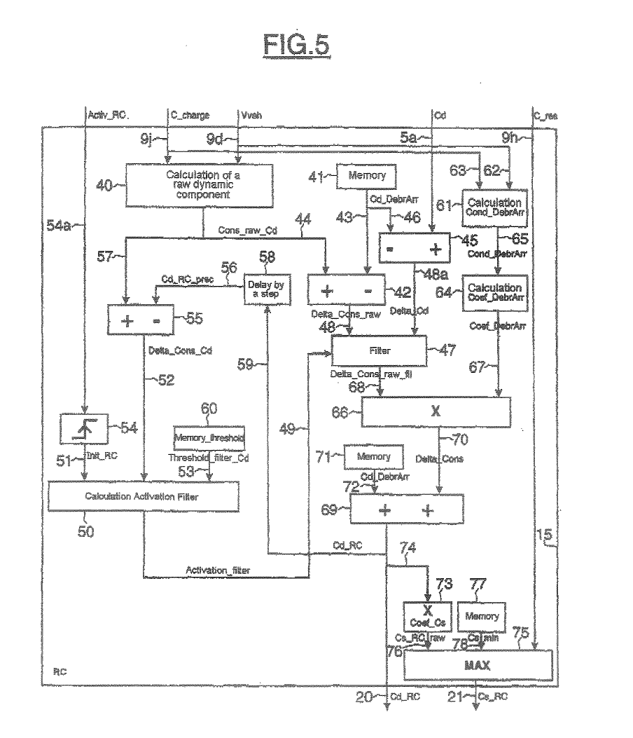

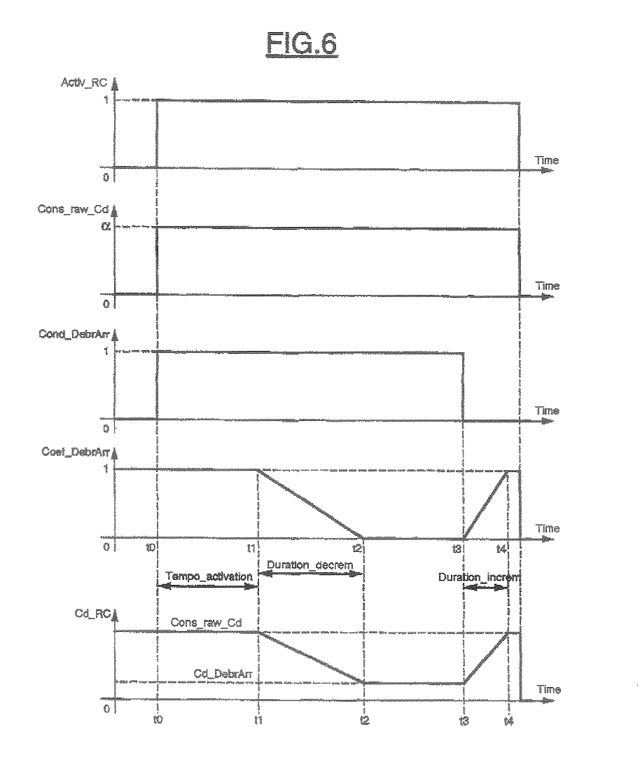

FIG. 5 illustrates in greater detail a module of the exemplary embodiment represented in FIG. 1,

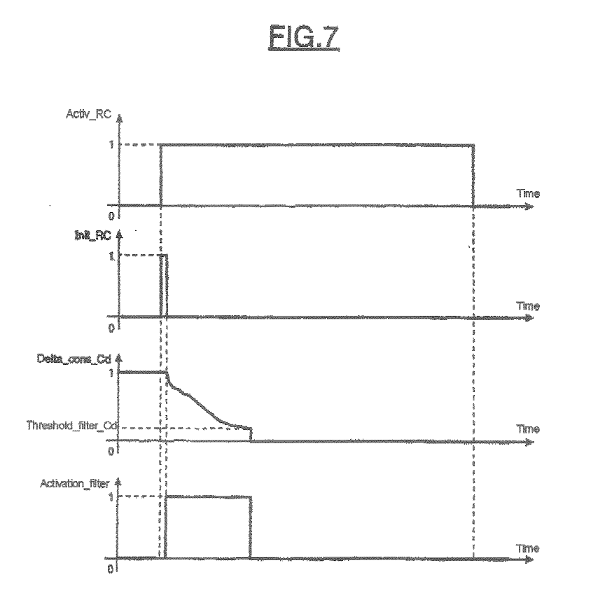

FIGS. 6 to 8 represent timecharts related to operation of the module represented in FIG. 5.

Represented diagrammatically in FIG. 1 is an example of an embodiment of the device according to the invention. This device can be included in a control box for a motor vehicle automated transmission, not represented in the figure.

Such as is illustrated in FIG. 1, the control device comprises an input block 1 transmitting data to a control block 2. The latter delivers various setpoints according to each operating mode to a selector 3. A selection module 4 dispatches, as a function of the input data delivered by the input block 1 via the connection 4a, a control signal “mode” to the selector 3 via the connection 4b. The selector 3 selects, from among the various setpoints delivered by the control block 2, the setpoint suited to the control signal “mode” and delivers the setpoint signal. This signal comprises two components, one static Cs which travels via the connection 6 and the other dynamic Cd which travels via the connection 5.

The static component Cs in the example illustrated, is the maximum value of the torque applicable to the wheels of the motor vehicle that the driver could request and that the power train must immediately make available to the wheels of the motor vehicle.

In other variants, the magnitudes formulated by the device can be a force or a power.

The input block 1 comprises three modules 7, 8 and 9 which will formulate a data signal on the basis of the signals arising from sensors, not represented, integrated within the motor vehicle.

The module 7 is capable of formulating the data relating to the characteristics of the motor vehicle. The latter are programmed and stored by the constructor so as to characterize the behaviour of the vehicle delivered to a customer.

The module 8 is capable of formulating data relating to the desire of the driver (man/machine interface, MMI). These data interpret the wishes that the driver transmits. By referring to FIG. 2 which describes more precisely the data formulated by the module 8, it is noted that it delivers signals such as a signal traveling via the connection 8d corresponding to the control lever for the transmission of the motor vehicle traveling via the connection 8a, a signal traveling via the connection 8e corresponding to the brake of the motor vehicle 8b, or else a signal traveling via the connection 8f representative of the depression of the pedal for accelerating the motor vehicle 8c.

The module 9 is capable of formulating signals relating to the environment of the motor vehicle. These make it possible to take account of the state of the motor vehicle and of its situation in the environment. By referring to FIG. 3 which describes more precisely the data formulated by the module 9, it is noted that it delivers signal such as a signal traveling via the connection 9d corresponding to the speed of the motor vehicle 9a, a signal traveling via the connection 9e and representative of the state of the carriageway 9b, a signal traveling via the connection 9f and representative of the meteorological conditions 9c, a signal traveling via the connection 9h and representative of the resistive torques 9g applied to the wheel that the vehicle must overcome so as to be able to move off or else a signal traveling via the connection 9j and corresponding to the whole set of resistive torques 9i applied to the motor vehicle, measured at the wheel of the motor vehicle and representative of the load carried on board by the motor vehicle and/or unevennesses of the road profile.

The value of the parameters and the state of the variables of the input data transmitted by these three modules are stored in a memory, not represented, common to each element of the device.

The control block 2 possesses four distinct modules each corresponding to a particular operating mode of the motor vehicle. These control blocks receive all the input data of the input block 1 via four distinct connections respectively the connection 10 for the first module 14 of the control block 2, the connection 11 for the second module 15, the connection 12 for the third module 16 and the connection 13 for the fourth module 17.

The four modules of the control block 2 are capable of delivering a setpoint signal according to four different modes, namely the “Continuous Control” mode, the “Speed Creeping” mode, the “Torque Creeping” mode and the “Neutral” mode.

As a function of the values of the input parameters, a first configuration represented in FIG. 1 holds. The mode chosen by the selection module 4 is the “Continuous Control” mode termed “CC” mode corresponding to the operating mode module 14. This mode is used when the speed of the motor vehicle is greater than a certain predetermined threshold. Moreover, it is necessary that the module of the “Continuous Control” mode continually generates its setpoint at the wheels of the motor vehicle even when it is not chosen by the selection module 4 since the value of the dynamic setpoint in “Continuous Control” mode, serves as reference value for the selection module 4 to which it is transmitted via the connection 4c. By way of example it is possible to refer to the document FR-A-2827339, this “Continuous Control” mode pertains to the module for interpreting the desire of the driver, IVC. The “CC” mode is able to generate a dynamic setpoint “Cd_CC” and a static setpoint “Cs_CC” respectively transmitted to a first input of the selector 3 via the connections 18 and 19. In this configuration where the “CC” mode is chosen, the selector 3 then selects said first input by establishing a connection 26 between its first input and its output. The selector 3 can then deliver the static and dynamic setpoints Cs and Cd corresponding respectively to the setpoints “Cs_CC” and “Cd_CC”.

As a function of the values of the input parameters, it is possible to be in a second configuration. The mode chosen by the selection module 4 is the “Torque Creeping” mode termed “RC” mode corresponding to the operating mode module 15 and which is an additional mode with respect to document FR-A-2827339. The “RC” mode is activated when the motor vehicle advances at low speed while idling with the brake activated. It makes it possible to generate a dynamic setpoint “Cd_RC” and a static setpoint “Cs_RC” respectively transmitted via the connections 20 and 21 to a second input of the multiplexer 3. Furthermore, the dynamic setpoint Cd undergoing application is transmitted via the connection 5a with the module 15 so as to formulate a new dynamic setpoint. This formulation method will be seen in greater detail hereafter. In the configuration where the “RC” mode is chosen, the selector 3 selects said second input by establishing a connection 27 between its second input and its output. The selector 3 can then deliver the static and dynamic setpoints Cs and Cd respectively corresponding to the setpoints “Cs_RC” and “Cd₁₃ RC”.

As a function of the values of the input parameters, it is possible to be in a third configuration. The mode chosen by the selection module 4 is the “Speed Creeping” mode termed “RV” mode corresponding to the operating mode module 16 and which is also an additional mode with respect to document FR-A-2827339. The “RV” mode is activated when the motor vehicle advances while idling but with the brake inactive. It makes it possible to generate a dynamic setpoint “Cd_RV” and a static setpoint “Cs_RV” respectively transmitted via the connections 22 and 23 to a third input of the multiplexer 3. In this configuration where the “RV” mode is chosen, the selector 3 selects said third input by establishing a connection 28 between its third input and its output. The selector 3 can then deliver the static and dynamic setpoints Cs and Cd corresponding respectively to the setpoints “Cs_RV” and “Cd_RV”.

As a function of the values of the input parameters, it is possible to be in a fourth configuration. The mode chosen by the selection module 4 is the “Neutral” mode corresponding to the operating mode module 17 and which is also an additional mode with respect to document FR-A-2827339. the “Netural” mode is activated when the control lever of the automated transmission is in the “Parking” position termed “P” that is to say in the latching position, or in the “Neutral” position termed “N” that is to say when the motor vehicle is freewheeling. It makes it possible to generate a dynamic setpoint “Cd_Neutral” and a static setpoint “Cs_Neutral” respectively transmitted via the connections 24 and 25 to a fourth input of the selector 3. In this configuration where the “Neutral” mode is chosen, the selector 3 selects said fourth input by establishing a connection 29 between its fourth input and its output. The selector 3 can then deliver the static and dynamic setpoints Cs and Cd corresponding respectively to the setpoints “Cs_Neutral” and “Cd_Neutral”.

The unselected operating mode modules are capable of generating a default setpoint although according to a variant of the invention, they could also generate a setpoint only if they were selected, except the module 14 of the “Continuous Control” mode which must deliver a setpoint in all cases.

FIG. 4 illustrates the operation of the selection module 4 during the choice of the operating mode.

First of all, the selection module 4 adopts a sequential operating mode. The updating of the value of the input parameters is performed periodically.

The flowchart represented in FIG. 4, shows the various analysis and comparison tests carried out on the data formulated by the input block 1 and transmitted via the connection 4a. These tests are carried out by various comparison means according to the following process.

At each refresh, a first step 30 consists in verifying the state of the control lever. If the latter is in the position termed “Parking” or “P”, or termed “Neutral” or “N” (lever at P OR lever at N), then the Neutral mode 31 is chosen.

If the control lever of the motor vehicle is neither in the “Parking” position nor in the “Neutral” position, the selection module passes to a Step 32 and verifies the depression of the acceleration pedal Pedacc, the value of the dynamic component of the current setpoint Cd and the speed of the motor vehicle Vveh.

To validate this step 32, either the depression of the acceleration pedal of the motor vehicle is strictly greater than a predetermined threshold of depression of the acceleration pedal and, simultaneously, the dynamic component of the current setpoint is strictly less than the dynamic component of the setpoint sent by the “Continuous Control” mode, or the speed of the motor vehicle is strictly greater than a first predetermined speed threshold ((Pedacc>threshold_ped AND Cd_CC>Cd) OR Vveh>threshold_vv_out. The chosen mode is then the “Continuous Control” mode 33. Otherwise, we pass to the following test step 34.

During step 34, the depression of the acceleration pedal of the motor vehicle Pedacc and the speed of the motor vehicle Vveh are tested. If the depression of the acceleration pedal of the motor vehicle is less then or equal to the predetermined threshold of depression of the acceleration pedal and, simultaneously, if the speed of the motor vehicle is strictly less than a second predetermined speed threshold (Pedacc<=threshold_ped AND Vveh<threshold_vv_in) then we pass to a following test step 36.

If these conditions do not hold then the current mode 35 is retained.

During step 36, the activity of the brake of the motor vehicle brake is considered. If the latter is active (brake active), then the “Torque Creeping” mode 37 is chosen, otherwise the “Speed Creeping” mode 38 is chosen.

The two predetermined and distinct speed thresholds threshold_vv_in and threshold_vv_out make it possible to avoid the phenomena of hysteresis to which the device could be sensitive that is to say the phenomena of oscillations between two operating modes on account of the oscillation of the value of a parameter about a predetermined threshold.

Conventionally, a hysteresis curve possesses two triggering thresholds allowing a given output variable to change value. Specifically, if there were a single decision threshold, the smallest variation of the value of the input variable, due for example to noise, would make the output variable oscillate between the two values.

Also, the first threshold of the hysteresis curve allows the output variable to change value if the input variable decreases, and the second threshold if the input variable increases, the value of the second threshold being higher than that of the first threshold.

FIG. 5 describes more particularly the operating mode module 15 corresponding to the “Torque Creeping” mode presented in FIG. 1. This mode corresponds to an advance at low speed while idling of the motor vehicle, that is to say when the speed of the motor vehicle is less than the second predetermined speed threshold, when the acceleration pedal is less than another predetermined threshold, with the brake pedal activated, as indicated in FIG. 4.

The “Torque Creeping” mode furthermore comprises a particular operating state termed “drag reduction while stationary”. This state is activated when the motor vehicle is stationary while it is in the “RC” mode, so as to decrease the motor torque. In this way, the fuel consumption of the motor vehicle is reduced. The module 15 receives various input parameters such as a signal denoted C_load, representative of the whole set of resistive torques applied to the motor vehicle, measured at the wheel of the motor vehicle and representative of the load carried on board by the motor vehicle and/or of the unevennesses of the road profile.

The module 15 furthermore receives a signal representative of the speed of the motor vehicle denoted Vveh, the value of the preceding dynamic setpoint denoted Cd, and a signal denoted C_res, representative of the resistive torques applied to the wheel and that the motor vehicle must overcome so as to be able to move off.

These various parameters originate from the input block 1 represented in FIG. 1. The module 15 also receives as input a signal denoted “Activ_RC” delivered by a piece of software (not represented) instructing the device, “Activ_RC” taking the value “1” during the activation of the “RC” mode, such as represented on the curve “Activ_RC” of FIG. 6.

FIG. 5 is referred to again. The module 15 comprises a first block 40 (Calculation of a raw dynamic component) able to formulate a raw dynamic component “Cons_raw_Cd”, which makes it possible to adapt the dynamic component in “RC” mode to the load and/or to the slope of the road. The setpoint “Cons_raw_Cd” is determined with the aid of a calibratable mapping (not represented) of the module 40, as a function of the input signals C_load and Vveh respectively delivered to the module 40 via the connections 9j and 9d. The evolution of the setpoint “Cons_raw_Cd” is represented in FIG. 6. The setpoint “Cons_raw_Cd” takes a predetermined value when the variable “Activ_RC” equals “1”, and the value “0” otherwise.

FIG. 5 is referred to again. The module 15 also comprises storage means 41 (Memory), able to deliver a target setpoint “Cd_DebrArr” having a value calibrated as a function of the type of motor vehicle considered. The target setpoint “Cd_DebrArr” represents the value to be attained by the dynamic torque component “Cd_RC”, when the motor vehicle is in the “drag reduction while stationary” state. In the “drag reduction while stationary” state the dynamic torque setpoint “Cd_RC” must therefore evolve progressively from the value “Cons_raw_Cd”, generated by the module 40, to the target setpoint “Cd_DebrArr”.

For this purpose, the target setpoint “Cd_DebrArr” is delivered to a first subtracter 42 by way of a connection 43. The subtracter 42 also receives as input “Cons_raw_Cd” via the connection 44. The function of the subtracter 42 is to deduct the value of the target setpoint “Cd_DebrArr” from the setpoint “Cons_raw_Cd”. The subtracter 42 generates as output a first intermediate variable “Delta_Cons_raw”. This operation makes it possible to adjust the setpoint “Cons_raw_Cd” and Cd_DebrArr” independently without modifying the adjustments of the timeouts “Duration_decrem” and “Duration_increm” (described in greater detail hereafter), thus accelerating the fine-tuning phase.

The module 15 comprises a second subtracter 45 receiving as input the target setpoint “Cd_DebrArr” via a connection 46 and the dynamic component “Cd” of the setpoint undergoing application in the last selected operating mode, delivered via the connection 5a. The subtracter 45 delivers a second intermediate variable “Delta_Cd” representative of the dynamic component “Cd” of the setpoint undergoing application, but decreased by the value of “Cd_DebrArr”.

A temporal filter 47 receives as input the setpoint “Delta_Cons_raw” via a connection 48 with the aim of filtering this setpoint as a function of the setpoint “Delta_Cd” also delivered as input via a connection 48a. The filtering performed by the filter 47 makes it possible to smooth the jump from the earlier setpoint “Delta_Cd” to the new setpoint “Delta_Cons_raw” and thus to avoid abrupt torque variations. The filter 47 delivers as output a variable “Delta_Cons_raw_fil”, representative of “Delta_Cons_raw”, but filtered.

The filter 47 is activated by a validation signal “Activation_filter” delivered to the filter 47 via a connection 49.

The validation signal “Activation_filter” is delivered by a second block 50 (Filter Activation Calculation).

The block 50 receives as input three variables, respectively “Init_RC” via a connection 51, “Delta_cons_Cd” via a connection 52 and “Threshold_filter_Cd” via a connection 53.

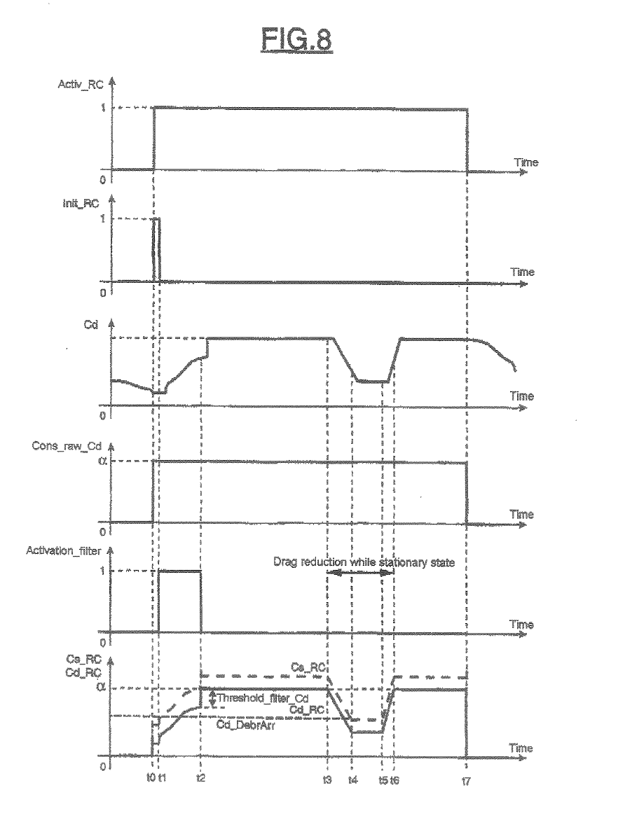

The variable “Init_RC” is an initialization signal formulated by a module 54 as a function of the variable “Activ_RC” delivered to the module 54 via a connection 54a. The module 54 generates a step over a time span during the activation of the “RC” operating mode, that is to say when the variable “Activ_RC” switches from the value “0” to the value “1”. At the conclusion of this time span, the variable “Init_RC” reverts to the value “0”. FIG. 7 represents the evolution of the variable “Init_RC” as a function of the values of the variable “Activ_RC”.

FIG. 5 is referred to again. The variable “Delta_cons_Cd” arises from a third subtracter 55. the function of the subtracter 55 is to deduct a variable “Cd_RC_prec”, transmitted to the subtracter 55 via a connection 56, from the setpoint “Cons_raw_Cd” transmitted to the subtracter 55 via a connection 57.

The variable “Cd_RC_prec” is equal to the setpoint “Cd_RC” but delayed by a time span. For this purpose, the module 15 comprises a module 58 (Delay by one span), receiving as input via a connection 59 the setpoint “Cd_RC”, that it delays by a time span.

The value of the variable “Delta_cons_Cd” is compared with a threshold value “Threshold_filter_Cd” delivered by a map stored by a memory 60 (Memory_threshold).

The module 50 can then deliver the validation signal “Activation_filter” when it has been activated by the signal “Init_RC” ad so long as the variable “Delta_cons_Cd” is less than the threshold “Threshold_filter_Cd”, such as may be seen on the curves “Delta_cons_Cd” and “Activation_filter” of FIG. 7. The filter 47 is therefore activated in a temporary manner at each entry into the “RC” operating mode, where it is initialized to the value “Delta_Cd” the latter taking the value of “Cd” decreased by “Cd_DebrArr”.

FIG. 5 is referred to again. The module 15 also comprises a third block 61 (Calculation Cond_DebrArr). The block 61 formulates a state variable “Cond_DebrArr” whose role is to indicate if all the conditions are jointly satisfied for triggering the “drag reduction while stationary” state. These conditions depend on the motor vehicle speed delivered to the block 61 via a connection 62 and the whole set of resistive torques C_load transmitted to the module 6 via a connection 63.

The “drag reduction while stationary” state is triggered if the speed Vveh of the motor vehicle is less than a first calibratable threshold (not represented) and if the whole set of resistive torques C_load is less than a second calibratable threshold (not represented). The second calibratable threshold makes it possible not to activate the “drag reduction while stationary” state in the case of large slope and/or load.

When these conditions are jointly satisfied the signal “Cond_Debr_Arr” takes the value “1” as represented in FIG. 6, by the curve “Cond_DebrArr”.

FIG. 5 is referred to again. A fourth module 64 (Calculation Coef_DebrArr) formulates as a function of the signal “Cond_DebrArr”, transmitted via a connection 65, a modulation coefficient “Coef_DebrArr”.

As illustrated in FIG. 6, the coefficient “Coef_DebrArr” is equal to “1” for a first duration “Tempo_activation” onwards of a moment t0, when the state signal “Cond_Debr_Arr” takes the value “1”. The duration “Tempo_activation” is determined so as not to activate the drag reduction immediately, in particular in parking a maneuver situations. “Tempo_activation” is calculated so as to establish a compromise between the maneuvering comfort of the motor vehicle and the fuel consumption.

At the conclusion of this time “Tempo_activation” at the moment t1, the coefficient “Coef_DebrArr” decreases regularly for a duration “Duration_decrem” from t1 up to a moment t2, with the proviso that the conditions on Vveh and C_load are always complied with. At the moment t2, the coefficient “Coef₁₃ DebrArr” takes the value “0” and retains it until the end of the “Drag reduction while stationary” state at the instant t3, where “Cond_Debr_Arr” is no longer activated and takes the value “0” where the “RC” mode is exited. In the case where one remains in the “RC” mode, the coefficient “Coef_DebrArr” is again incremented for a duration “Duration_increm” until it attains the value “1” at the instant t4. The durations “Tempo_activation”, “Duration_decrem” and “Duration_increm” are calibratable as a function of the type of vehicle.

FIG. 5 is referred to again. The modulation coefficient “Coef_DebrArr” is transmitted to a multiplier 66 via a connection 67. The multiplier 66 also receives as input the filtered setpoint “Delta_Cons_raw_fil” via a connection 68. The multiplier 66 then applies the coefficient “Coef_DebrArr” to the setpoint “Delta_Cons_raw_fil”.

The multiplier 66 then delivers a setpoint “Delta_Cons” to an adder 69 via a connection 70. The adder 69 formulates the dynamic component “Cd_RC” of the setpoint in “RC” mode, by adding the variable “Cd_DebrArr” formulated by a memory 71 (Memory) and delivered to the adder 69 via a connection 72.

The adder 69 delivers the dynamic component “Cd_RC” of the setpoint in “RC” mode via the connection 20, represented in FIG. 6 by the curve “Cd_RC”.

In FIG. 5, the module 15 also comprises means for formulating the static component of the setpoint “Cs_RC” in “RC” mode, on the basis of the setpoint “Cd_RC”.

Accordingly, it comprises a block 73 formulating a setpoint “Cs_RC_raw” on the basis of the dynamic component of the setpoint “Cd_RC” transmitted via a connection 74 to the block 73. The block 73 formulates the static component “Cs_RC_raw” by multiplying the setpoint “Cd_RC” by a coefficient Coef_Cs, representing a desired torque reserve applicable to the wheel.

A block 75 (MAX) receives as input the setpoint “Cs_RC_raw” via a connection 76, as well as a constant “Cs_min” delivered to the module 75 by a memory (Memory) 77, by way of a connection 78. The constant “Cs_min” represents a minimum torque quantity to be applied to the wheel. The block 75 also receives as input via the connection 9h, the signal C_res representative of the resistive torques applied to the wheel and positioning the power train so as to allow an immediate pullaway of the motor vehicle. The block 75 formulates the static component “Cs_RC” by taking the maximum of the three signals received as input.

FIG. 8 takes up again the evolution of the setpoints “Cd_RC” and “Cs_RC” of the “RC” operating mode.

At the instant t0, the variable “Activ_RC” takes the value “1”, as well as the variable “Init_RC”, which reverts to the value “0” after a time span, at the instant t1.

At the conclusion of this time span t1, the validation signal “Activation_filter” takes the value “1” allowing the variable “Cd_RC” to increase progressively, until the difference between “Cd_RC” and the value of “Cons_raw_Cd” (activated at t0), α, is less than “Threshold_filter_Cd”, at the instant t2. The validation signal “Activation_filter” then reverts to the value “0”.

At the instant t2, the variable “Cd_RC” takes the value of “Cons_raw_Cd” until the instant t3 where the motor vehicle is in the “drag reduction while stationary” state. The setpoint “Cd_RC” decreases until it attains the value “Cd_DebrArr” at t4.

At t5, the motor vehicle still being in the “RC” mode, the setpoint “Cd_RC” exits the “drag reduction while stationary” state, therefore progressively increasing until it attains the value of “Cons_raw_Cd”, that is to say α at t6.

The setpoint “Cd_RC” retains this value up to t7 where the “RC” mode (Activ_RC=0) is exited.

The evolution of the setpoint “Cs_RC” follows that of the setpoint “Cd_RC” to within a coefficient “Coef_Cs”. In this example, it is assumed that there is no saturation related to “Cs_min” or to “Cs_res”.

The formulation of the dynamic component of the setpoint in “RC” mode offers several advantages. It makes it possible for example to make the vehicle advance independently of its load and/or of the slope of the road. Furthermore, the motor vehicle can maintain a speed lying between the zero speed and the second threshold speed threshold_vv_in which can be of the order of 6 to 10 km/h according to the type of motor vehicle, then attain a zero speed, independently of the load of the motor vehicle and/or of the slope of the road. Moreover, by virtue of the “drag reduction while stationary” state, the drag forces and thus the fuel consumption of the motor vehicle are reduced.

The “RC” mode is therefore particularly suited to maneuvers performed with the aim of parking the motor vehicle.

1-7. (canceled)

8. A method of controlling an automated transmission of a power train for a motor vehicle, comprising:
formulating a setpoint signal of a variable to be applied to wheels of the motor vehicle, the setpoint including a dynamic component and a static component formulated by taking account of input data representative of characteristics of the motor vehicle, of a desire of a driver, and of an environment of the motor vehicle,
wherein, as a function of the input data, a mode is selected from among at least first and second different operating modes, capable of delivering the setpoint signal, the first mode corresponding to a torque creeping mode configured to deliver the setpoint signal when the motor vehicle advances at a speed less than a predetermined threshold and when the brake pedal of the motor vehicle is activated.

9. The method as claimed in claim 8, wherein the torque creeping mode and/or a value of the setpoint delivered when the torque creeping mode is selected, are determined as a function of a signal representative of a whole set of resistive torques applied to the motor vehicle, measured or estimated at the wheels of the motor vehicle and representative of a load carried by the motor vehicle and/or of unevennesses of a road profile.

10. The method as claimed in claim 9, wherein the torque creeping mode and/or a value of the setpoint delivered when the torque creeping mode is selected, are determined as a function of a signal representative of the dynamic component of the setpoint undergoing application.

11. The method as claimed in claim 10, wherein the torque creeping mode and/or a value of the setpoint delivered when the torque creeping mode is selected, are determined as a function of a signal representative of resistive torques applied to the wheels and that the motor vehicle must overcome to be able to move off.

12. A device for controlling an automated transmission of a power train for a motor vehicle, configured to deliver setpoint signals of a variable to be applied to wheels of the motor vehicle, the setpoint including a dynamic component and a static component, formulated by taking account of input data, delivered by an input block and including a list of parameters defining characteristics of the motor vehicle, a desire of the driver, and an environment of the motor vehicle, the device comprising:
a control block including at least two modules corresponding to two distinct and predetermined operating modes, one of the modules corresponding to a torque creeping mode selected when the motor vehicle advances at a speed less than a predetermined threshold, when an acceleration pedal is less than a predetermined threshold, and when the brake pedal of the motor vehicle is activated; and
a selection module receiving signals originating from the input block and configured to deliver a selection signal for an operating mode module as a function of the input data.

13. The device as claimed in claim 12, wherein the module for the torque creeping mode comprises:
a first block configured to formulate a raw dynamic component of the setpoint as a function of a predetermined list of parameters,
a temporal filter configured to delay a variable received as an input,
a second block configured to formulate a validation variable to activate the temporal filter, when a signal indicating entry into the torque creeping mode switches from a first value to a second value,
a third block configured to formulate a state variable indicating operation in a drag reduction while stationary phase, as a function of the first predetermined list of parameters,
a fourth block configured to calculate a modulation coefficient based on the state variable, so as progressively to apply correction afforded during the drag reduction while stationary phase,
means for performing operations on the variables delivered by the blocks included in the module intended for the torque creeping mode as a function of a third list of predetermined input parameters,
means for delaying the dynamic component of the setpoint undergoing application,
means for storing calibratable parameters,
means for comparing the dynamic component, a value of a raw static component, and a minimum torque quantity applicable to the wheel, with a signal representative of resistive torques applied to the wheels and that the motor vehicle must overcome to be able to move off.

14. The device as claimed in claim 12, wherein the list of predetermined parameters includes speed of the motor vehicle and a signal representative of a whole set of resistive torques applied to the motor vehicle.. measured or estimated at the wheels of the motor vehicle and representative of the load carried by the motor vehicle and/or of unevennesses of a road profile.
